(19) United States
(12) Patent Application Publication
(10) Pub. No.: US 2014/0204614 A1
(43) Pub. Date: Jul. 24, 2014

(54) RECTIFIED HIGH FREQUENCY POWER SUPPLY WITH LOW TOTAL HARMONIC DISTORTION (THD)

(71) Applicant: Carl Monroe Elam, Perry Hall, MD (US)

(72) Inventor: Carl Monroe Elam, Perry Hall, MD (US)

(21) Appl. No.: 14/158,071

(22) Filed: Jan. 17, 2014

Related U.S. Application Data
(60) Provisional application No. 61/754,284, filed on Jan. 18, 2013.
(60) Provisional application No. 61/754,304, filed on Jan. 18, 2013.

(51) Int. Cl. H02M 1/12

(52) U.S. Cl. CPC H02M 1/126
USPC 363/16

(57) ABSTRACT

A method and apparatus that performs AC to DC power conversions without creating significant 50 or 60 Hz harmonic currents and voltage distortions on the AC power source conductors thus minimizing the need for ancillary harmonic filtering of 50 or 60 Hz harmonics. The method and apparatus is embodied in a circuit that first performs balanced modulation on a 50 Hz or 60 Hz power voltage converting it to a higher frequency, then subsequently passing the resulting wave through a step-up transformer to produce a higher voltage wave and finally rectifying and filtering the higher voltage wave to produce a DC voltage. The higher frequency waveform may be pulse width modulated to effect output DC voltage regulation. The circuit is typically comprised of semiconductor switches, pulse control circuits, transformers, filter capacitors, filter inductors, semiconductor diode rectifiers, DC voltage measurement circuits and other components.

### CROSS-REFERENCE TO RELATED APPLICATION(S)

The present application derives priority from U.S. Provisional Patent Application 61/754,284 filed 18 Jan. 2013 and U.S. Provisional Patent Application 61/754,304 filed 18 Jan. 2013.

### BACKGROUND OF THE INVENTION

1. Field of the Invention

The present invention relates to power supplies and, more particularly, to a rectified high frequency AC/DC power supply with low total harmonic distortion (THD).

2. Description of the Background

Many types of modern electrical equipment require the conversion of AC power to DC power. Equipments that require greater amounts of DC power tend to create more harmonic currents in their AC power source wiring. Examples of equipment that may require large amounts of DC power include: electric motor variable speed power units, emergency AC backup power units and electric railroad 700 Volt DC power supplies.

Modern electric motor variable speed power units are used in factories, municipal water facilities and elsewhere to operate motors over a range of speeds; these motor power units are often referred to as variable speed drives (VSD's) and as variable frequency drives (VFD's). The circuits within these units require that the incoming utility AC Power be first converted into DC Power. Subsequently, the DC Power is converted back into AC Power using electronic circuitry with the added feature that the frequency of the newly created AC Power may be varied from nearly zero Hz to some value greater than 60 Hz. This feature permits variable speed operation of conventional AC Induction Motors.

Emergency AC backup power units, commonly known as Uninterruptible Power Systems (UPS), are often used to reliably power large computer facilities and hospital emergency medical equipment. These units are constructed in a manner similar to the electric motor variable speed power units except that the output frequency is set to a constant frequency of 50 Hz or 60 Hz. In addition, for UPS equipment the DC Power is connected to a large array of batteries that can store up to several hours of energy for later conversion to AC Power during a prolonged utility power outage.

Electrified DC railroad systems require numerous substations that produce large quantities of power for electrically operated trains. Typically, these trains utilize 700 Volt DC Power to operate their traction motors for propulsion. Each substation typically supplies several thousand Amperes of DC Current.

Normally large equipment such as traction power substations and larger models of VSD, VFD and UPS equipment require large amounts of DC power; that DC power may vary from several hundreds of kilowatts to several thousands of kilowatts.

There are also other important types of modern electrical equipments that individually may require smaller quantities of DC power but that are so pervasive throughout the power grid that they collectively constitute a significant portion of the total electrical load. These equipments include: modern lighting fixtures, personal electronic devices such as computers and also battery chargers for a new generation of all electric automobiles. It is estimated that the widespread recharging of electric automobiles could double the demand on the national power grid.

Traditionally, rectifier circuits for large equipments are comprised of full-wave bridge rectifier circuits connected to a three-phase AC utility power source. This arrangement will give a six-pulse rectified DC output current at the rectifier DC output terminals for every cycle of the utility source waveform. This six-pulse rectifier will cause significant harmonic currents on the three-phase AC power lines. Each cycle of each phase of the power line voltage will have two current pulses each having a duration of only 60 degrees.

The conventional rectifier circuits for equipments requiring less power may, on the other hand, be comprised of a full-wave rectifier connected to a single-phase utility power source. This arrangement will give a two-pulse rectified DC output current at the rectifier DC output terminals for every cycle of the utility source waveform. This single-phase rectifier will normally cause significant harmonic currents. Each cycle of the power line voltage will have two current pulses each having a short duration of 40 to 100 degrees.

Conventional rectifier circuits have the disadvantage of creating harmonic currents and accompanying voltage harmonic distortion on their AC power source conductors. These harmonic currents result from the fact that currents flow through the rectifier diodes for only a brief interval within each cycle of the power wave. The presence of harmonic currents and voltage distortion can damage or otherwise impair the performance of other equipments connected to the same electrical power source. In addition, these harmonics can cause energy inefficiencies and increase the risk of damage to components within the electrical distribution network of the plant and of the serving electric utility. It is essential, therefore, that these rectifier circuits produce no significant harmonic currents and no significant voltage distortions.

To minimize the magnitude of the harmonics, the AC power lines feeding conventional rectifier circuits are often equipped with harmonic filters, e.g., 50 or 60 Hz harmonic filters, that reduce the magnitude of harmonics on the AC power conductors.

The prior art technology frequently utilizes series chokes as low-pass filter components to reduce or mitigate the harmonic currents and voltage distortions created on the AC power source conductors by rectifier circuits. In the prior art designs, series chokes are frequently connected at the AC input wires of the rectifiers and in addition series chokes are also frequently connected between the rectifier DC output and the filter capacitors. A choke, as used for such applications, is an inductor that is constructed by winding a coil of insulated copper or aluminum wire on an iron core material. These chokes will reduce or mitigate the harmonic currents and the accompanying voltage distortions. There are problems, however, associated with using filter chokes. Filter chokes connected in series with a rectifier output will reduce the DC output voltage. This may be a disadvantage in some applications.

In addition, filter chokes connected at the AC input wires of a rectifier may interact with power factor correction capacitors elsewhere in the plant and the utility network and resonate with these capacitors, thus, producing damaging voltages on the power lines. These resonances may occur at the fundamental or at a harmonic of the power frequency.

There are also cost and space requirements associated with the installation of filter chokes used for harmonic current filtering. The physical size of such a choke may occupy a volume of three cubic feet or more. Space consumption of this magnitude is not preferred.

For very large DC power supplies the prior art technology frequently uses two large three-phase, 50 or 60 Hz transformers to reduce voltage ripples on the DC output. One transformer will have a delta secondary and the other will have a wye secondary. The secondary windings of these transformers each have full wave, three-phase rectifiers. Each secondary phase on the first transformer has a sixty degree phase shift with respect to the phases on the secondary of the second transformer. The rectifier outputs are combined to give a twelve-pulse rectified DC waveform. This twelve-pulse rectifier will cause significant harmonic currents on the three-phase AC power lines. Each cycle of each phase of the power line voltage will have four current pulses, each having a duration of only 30 degrees. To avoid the necessity of using large transformers and filter chokes, it is advantageous, therefore, to avoid creating harmonics, in the first place, by using circuits that inherently minimize their creation.

What is needed is a method and apparatus that performs AC to DC power conversions without creating significant 50 or 60 Hz harmonic currents and voltage distortions on the AC power source conductors thus minimizing the need for ancillary 50 or 60 Hz harmonic filtering.

### SUMMARY OF THE INVENTION

It is, therefore, an object of the present invention to provide a method and apparatus that performs AC to DC power conversions without creating significant 50 or 60 Hz harmonic currents and voltage distortions on the AC power source conductors thus minimizing the need for ancillary harmonic filtering of 50 or 60 Hz harmonics.

These and other objects are achieved herein by an AC to DC Power Supply Circuit that can preferably operate on three-phase power, such as 480 Volt AC Delta, or single-phase power, such as 240 Volts AC. The circuit is typically comprised of semiconductor switches such as IGBT's, pulse control circuits, transformers, filter capacitors, semiconductor diode rectifiers, DC voltage measurement circuits and other components.

For Single-Phase Applications:

A First Stage of the invention circuit is comprised of a 50 or 60 Hz AC Power Source and an Input Filter circuit. The input filter prevents high frequency waveforms generated within the rectifier circuits from conducting onto the 50 or 60 Hz power wiring.

A second stage of the invention circuit is comprised of a balanced modulator that is connected to an AC power source and modulates the AC power source, typically a 50 Hz or a 60 Hz sinusoidal wave, into a higher frequency waveform. This higher frequency waveform is preferably a double sideband suppressed carrier wave. For this description 4,320 Hz will be used for the higher frequency but other frequencies or number of pulses or cycles per second may also be used. The modulating components are semiconductor switches such as IGBT's. The switches turn on and turn off at a rapid pace thereby creating current pulses. The switches are arranged in a circuit so that the current pulses alternately flow in opposite directions at the modulator output. They alternate at a 4,320 Hz rate. These switches are controlled by a pulse control circuit. The pulse control circuit controls the current conduction intervals of the semi-conductor switches and thus the timing and frequency at which the higher frequency pulses occur and also the duration or width of each pulse. This control of pulse width characteristics of the higher frequency waveform will permit the instantaneous regulation of the 50 Hz or 60 Hz input current every few degrees within the power input waveform. The ability to instantaneously regulate the source current by using a microprocessor equipped pulse width controller can be exploited to properly shape the input current waveform and thus minimize the power source harmonics while also providing for the regulation of the rectifier DC output voltage. The input filter prevents the 4,320 Hz currents and their harmonics from being propagated onto the AC Power source conductors.

A third stage is comprised of a step-up transformer, with a typical secondary-to-primary turns ratio of four-to-one. The primary of this transformer is connected to the higher frequency waveform output from the modulator. The alternately flowing current pulses will flow through the primary winding and will produce a 4,320 Hz voltage waveform across the primary. The secondary of this transformer is connected to a full wave bridge rectifier circuit. The transformer design will be based upon the higher operating frequency of 4,320 Hz and thus this transformer will be significantly smaller than an equivalent 50 Hz or 60 Hz transformer. The volume and weight for the higher frequency transformer will be less than that of a conventional 50 or 60 Hz transformer of the same Volt-Ampere rating.

A fourth stage is comprised of a full-wave bridge rectifier circuit. The secondary of the transformer is connected to the input of the full-wave bridge rectifier. The rectifier circuit converts the higher frequency AC into a full wave rectified DC waveform. The rectifier output will contain current and voltage ripples that generally require filtering.

A fifth stage is a filter circuit comprised of a simple capacitor or one or more filter capacitors and choke coils typically arranged in a capacitor input, low-pass network. This filter will be designed to reduce the current and voltage ripples to an acceptable level.

The rationale for selecting the modulation frequency of 4,320 Hz is to permit instantaneous control of current flow to an increment of approximately 5-Degrees within a 50 Hz or a 60 Hz power waveform. A secondary benefit of increasing the frequency is that it permits the size of the third stage transformer to be significantly reduced. The rationale for the transformer having a four-to-one turns-ratio is to allow forward diode conduction through the fourth stage rectifiers over a greater portion of the positive and negative portions of the 50 Hz or 60 Hz power waveform. In a preferred embodiment, the DC output voltage is regulated to a voltage that is equal to one-forth of the zero-to-peak voltage of the transformer secondary.

The invention will achieve conduction over approximately 84% of a 50 Hz or 60 Hz power waveform whenever the choice of the third stage transformer turns ratio is four-to-one and the DC output voltage is approximately equal to one-fourth the peak voltage of the transformer secondary voltage. Under these conditions, the DC output Voltage will equal the zero-to-peak value of the input power AC Voltage. This is the same DC output Voltage that would be produced by a conventional full-wave bridge rectifier.

The rationale for varying the pulse width at the modulator is to vary the transformer secondary current into the rectifier diodes and subsequent filter circuit, thus permitting a means of rectifier output voltage regulation. This technique will additionally provide the benefit of allowing the instantaneous control the 50 Hz or 60 Hz input current within small increments of each cycle of the 50 Hz or 60 Hz power waveform.

An additional method of DC Voltage regulation may be achieved by varying the frequency of the pulse modulator. The rationale for varying the frequency of the pulse modulation would be to exploit any series reactance within the transformer circuit and its low pass frequency response. For example, if an appropriate value of inductive reactance is included within the transformer circuit, the current into the rectifier stage will be reduced as the pulse frequency is increased. Thus, variations in the pulse modulation frequency may be used to vary the transformer secondary current into the rectifier diodes, thereby providing a second means of output voltage and current regulation.

For three-phase applications, the configuration of the invention circuit is modified to include three single-phase AC to DC Power Supply Circuits, as described above. In this Three-phase configuration, each of the line-to-line phases or line-to-neutral phases of the three-phase AC power source is connected to an input of one of the three AC to DC Power Supply Circuits. The three circuits are preferably identical except they may share a common Pulse Control Circuit. The DC outputs of the three AC to DC Power Supply Circuits may also be shared in common by connecting them in either a parallel or a series configuration. To achieve a parallel common DC Voltage output, the rectifier outputs are preferably connected together in parallel and are input to a common filter in order to form a single filtered DC output. To achieve a common series DC output, each rectifier output and its respective filter are connected in series with the other two rectifiers and filters.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 illustrates a block diagram of a single-phase AC to DC Power Supply Circuit according to an embodiment of the present invention.

FIG. 2a illustrates the 50 or 60 Hz power source and input filter of the single-phase AC to DC Power Supply.

FIG. 2b illustrates a detailed circuit diagram for the single-phase AC to DC Power Supply circuit from the Modulator to the DC Output.

FIG. 2c illustrates the circuit details surrounding each IGBT semiconductor switch.

FIG. 2d illustrates an alternate Modulator circuit configuration.

FIG. 3a illustrates an oscillograph that illustrates one cycle of the 60 Hz input voltage to the modulator.

FIG. 3b illustrates the 4,320 Hz pulse modulated voltage waveform at the transformer primary.

FIG. 3c illustrates an alternate pulse width modulation.

FIG. 3d illustrates a full-wave rectified voltage.

FIG. 4 illustrates an enlarged view of the 4,320 Hz pulse modulated voltage waveform at zero crossing.

FIG. 5a illustrates a block diagram of the AC to DC Power Supply circuits connected to a three-phase power source and having the DC outputs connected in parallel to form a single DC output.

FIG. 5b illustrates a block diagram of the AC to DC Power Supply circuits connected to a three-phase power source and having the DC outputs connected in series to form a single DC output.

FIG. 6a illustrates a typical Three-Phase AC power source according to an alternate embodiment of the invention.

FIG. 6b illustrates an oscillograph for a Three-Phase AC power source.

FIG. 6c illustrates a Three-Phase 4,320 Hz pulse modulated voltage waveforms at the three transformer primaries.

FIG. 7a illustrates a first conventional single phase rectifier circuit and its respective input AC voltage waveform.

FIG. 7b illustrates a second conventional single phase rectifier circuit and its respective input AC voltage waveform.

FIG. 7c illustrates the input AC voltage waveform for a single phase rectifier of the type described for this invention.

FIG. 8 illustrates a passive and an active snubber circuit for connection across the transformer primary at the modulator output.

### DETAILED DESCRIPTION OF THE PREFERRED EMBODIMENT

The present invention is a method and apparatus for performing AC to DC power conversions without creating significant 50 or 60 Hz harmonic currents and voltage distortions on the AC power source conductors thus minimizing the need for ancillary 50 or 60 Hz harmonic filtering. The method and apparatus is embodied in a circuit that first performs balanced modulation on an AC power of a first frequency (e.g., a 50 Hz or 60 Hz power voltage) converting it to a higher frequency (a “first modulated power waveform” with power or voltage or current of a second frequency), and then subsequently passes the resulting first modulated power waveform through a step-up transformer to produce a higher voltage wave (a “second modulated power waveform”), and finally rectifies and filters the higher voltage second modulated power waveform to produce a DC voltage (the “rectified waveform”).

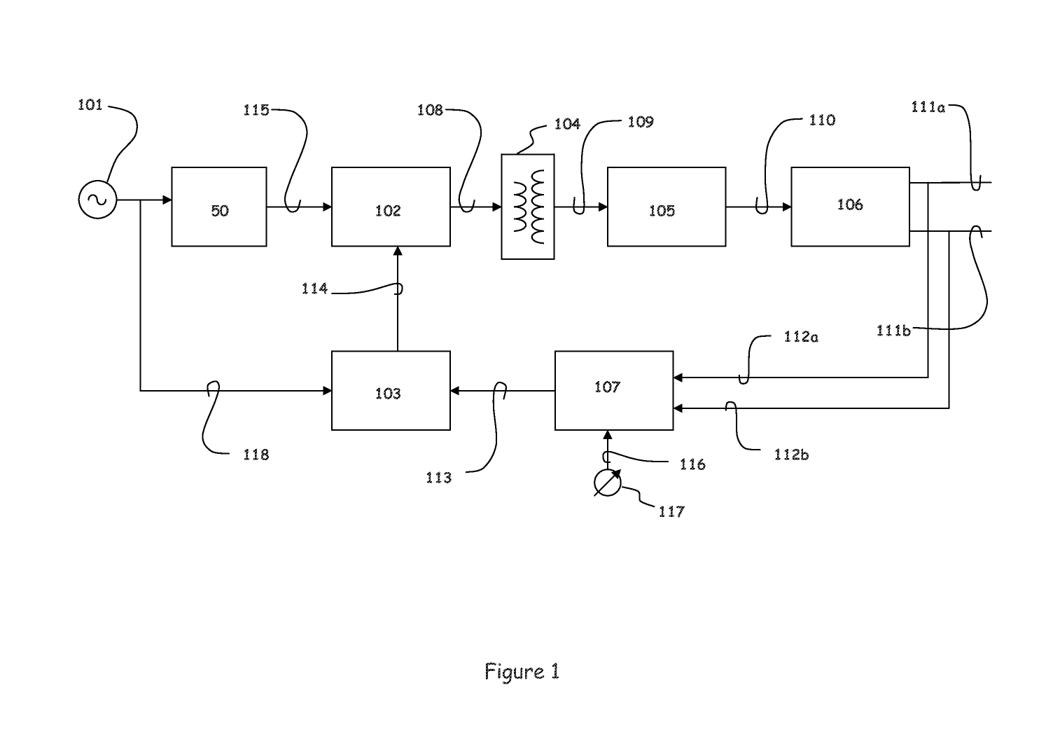

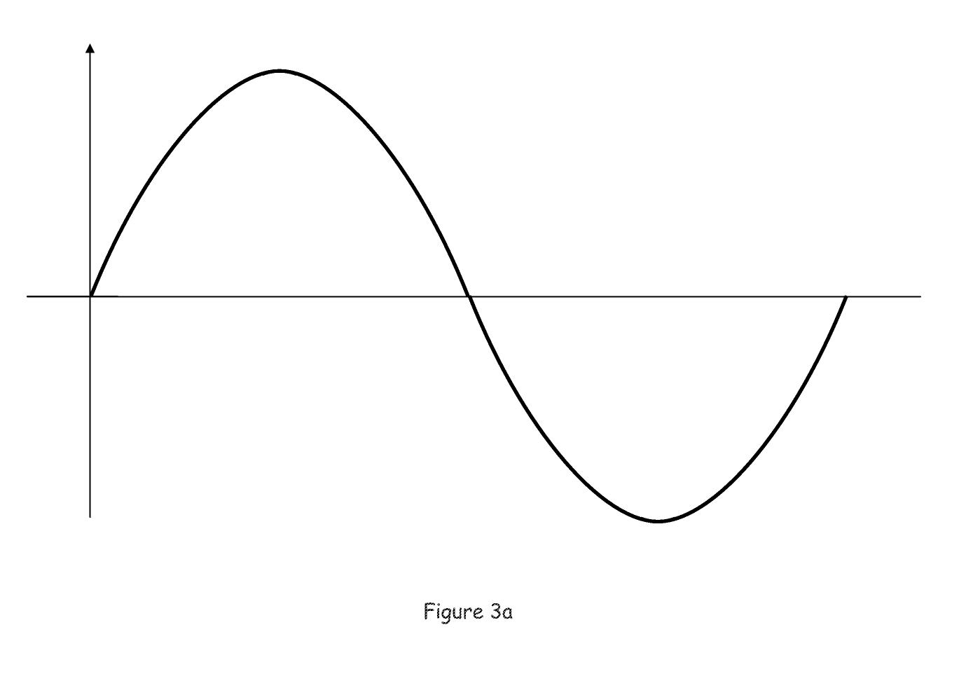

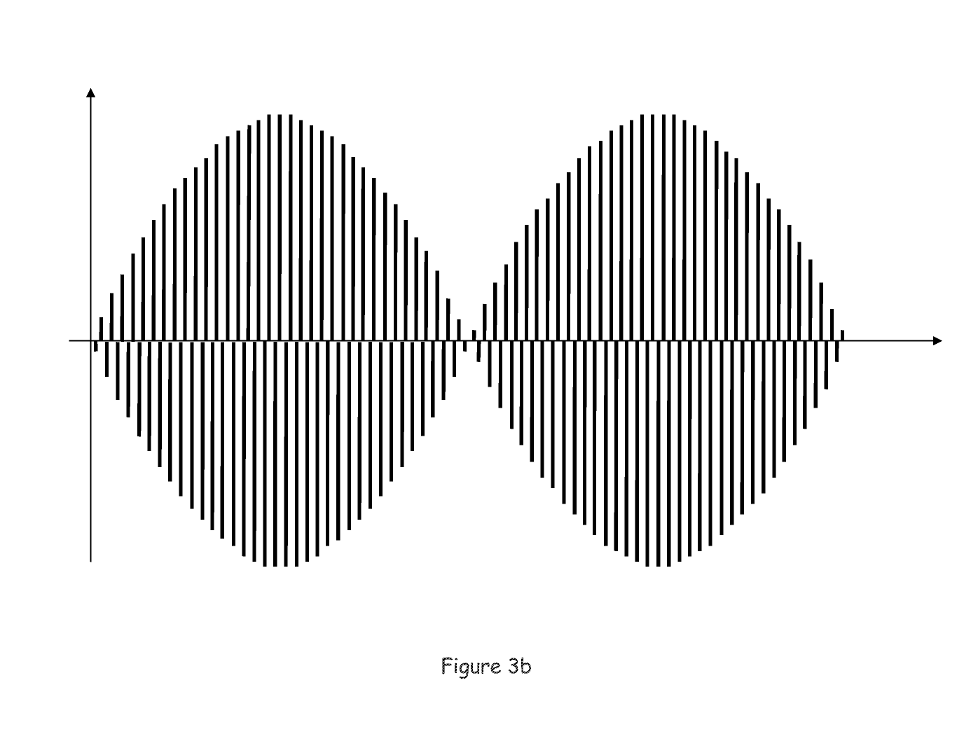

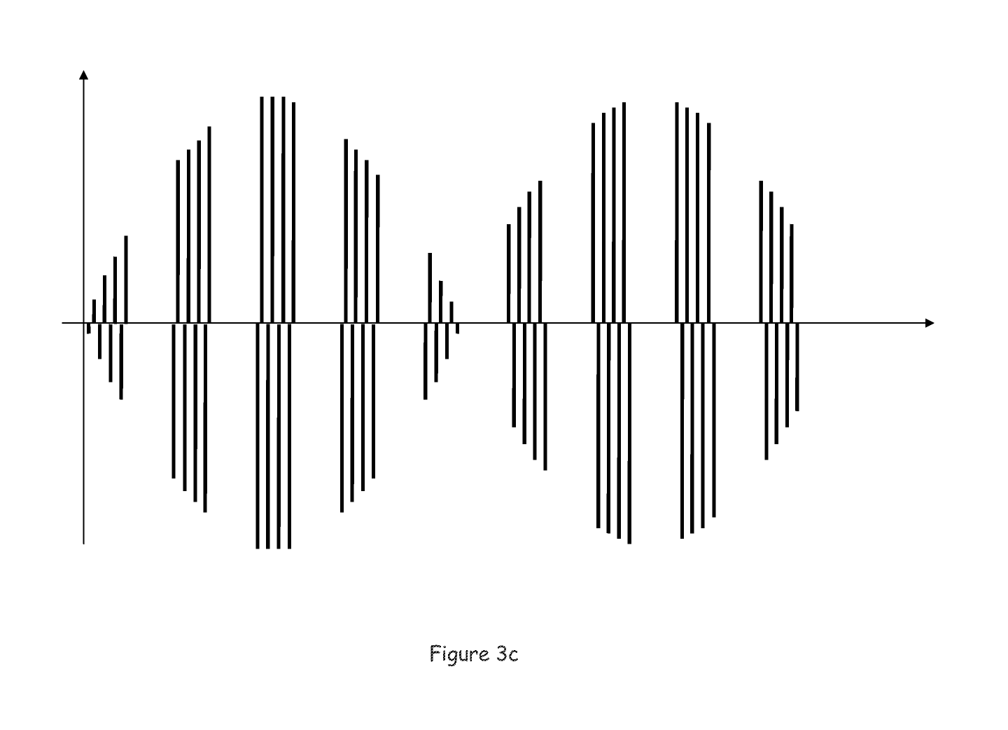

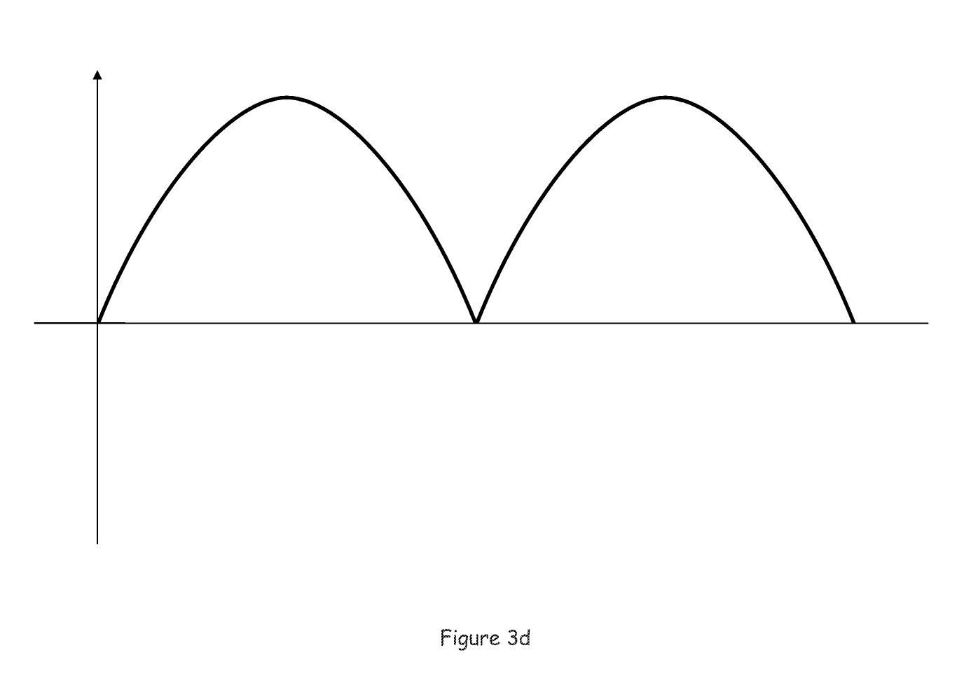

In an exemplary embodiment the first stage of the invention, illustrated in FIG. 1, is comprised of a 50 or 60 Hz AC Power Source 101 and Input Filter 50. The AC Power Source 101 outputs a Sinusoidal Wave, illustrated in FIG. 3a, that is typically 50 or 60 Hz. The AC Power Source 101 is connected to the filter 50 input. The filter 50 output at 115 is connected to the input of Modulator 102. The input filter 50 passes the 50 or 60 Hz power wave but prevents the higher frequency waveform and its harmonics generated within the Modulator 102 from conducting back onto the 50 or 60 Hz power wiring.

The Second Stage of the invention is comprised of Modulator 102. The Sinusoidal Wave at 115, illustrated in FIG. 3a, is input to the Modulator 102 which modulates the Sinusoidal Wave at 115 into a higher frequency first modulated power waveform at connection 108. The higher frequency first modulated power waveform is illustrated at FIG. 3b. The Modulator 102 is preferably configured as a balanced modulator. For this description 4,320 Hz will be used for the higher frequency first modulated power waveform but other frequencies or number of pulses or cycles per second may also be used. The Modulator 102 is controlled by a Pulse Control 103 via Pulse Control Connection 114. The Pulse Control 103 via Pulse Control Connection 114 controls the frequency and timing at which the pulses of the first modulated power waveform at 108 occur and also controls the duration or width of each pulse of the first modulated power waveform at 108 output from the Modulator 102.

The third stage, illustrated in FIG. 1, is comprised of a Transformer 104, with a typical secondary-to-primary turns ratio of four-to-one but other ratios may be used. The first modulated power waveform output from the Modulator 102 is fed to the primary of this Transformer 104 via connection 108. The Transformer 104 design will be based upon the higher operating frequency of a 4,320 Hz pulse waveform and thus Transformer 104 will be significantly smaller than a typical 50 Hz or 60 Hz transformer with the same Volt-Ampere rating. The output from the Transformer 104 is a second modulated power waveform at connection 109. The open-circuit second modulated power waveform at 109 is four times the magnitude of first modulated power waveform at 108. Values other than four-to-one may be used for the Transformer 104 secondary-to-primary turns ratio.

The fourth stage is Rectifier 105. The second modulated power waveform at 109 from the Transformer 104 output is connected to the input of the full wave Rectifier 105. Rectifier 105 converts the second modulated power waveform at 109 into a rectified waveform at connection 110. The rectified waveform at 110 output is a DC Voltage that contains current and voltage ripples that require filtering in order to produce a somewhat smooth DC Voltage.

The fifth stage is Filter 106. Rectified waveform at connection 110 is input to the Filter 106. The Filter 106 is typically comprised of one or more filter capacitors and choke coils arranged in a low-pass, capacitor input filter circuit configuration. The Filter 106 reduces the voltage ripples in the rectified waveform at 110 and outputs a Smoothed DC Voltage between output conductors 111a and 111b. The size of the circuit components in the filter for a 4,320 Hz waveform may be much smaller than those required to filter a rectified 50 Hz or 60 Hz waveform.

Voltage Control 107 is connected via Voltage Measurement Connections 112a and 112b to the DC output conductors 111a and 111b of Filter 106 to measure the smoothed DC Output Voltage. Voltage Control 107 may also receive a Voltage Command 116 from DC Controller 117. DC Controller 117 outputs Voltage Command 116 that Voltage Control 107 then compares with the magnitude of the Smoothed DC Output Voltage. Voltage Control 107 outputs information pertaining to voltage regulation via Voltage Control Connection 113 that is sent to Pulse Control 103. Pulse Control 103 utilizes the signals from the Voltage Control Connection 113 to influence the signals on Pulse Control Connection 114 in a manner that varies the value of the DC Output Voltage at output conductors 111a and 111b. The signals on Pulse Control Connection 114 will typically control the timing and pulse width of each half cycle of the first modulated power waveform at 108 that Modulator 102 outputs on Connection 108 onto the Transformer 104 primary winding. In addition, Pulse Control 103 may also utilize the AC Power Source 101 Sinusoidal Voltage Wave at sinusoidal wave connection 118 to control the signals on Pulse Control Connections 114. The sinusoidal wave connection 118 provides the Pulse Control 103 with knowledge of the polarity of the AC Power Source 101 Wave at every moment in time thus permitting pulse control 103 to turn ON and OFF the appropriate solid state switches (IGBT's) in the Modulator 102. The sinusoidal voltage waveform connection 118 also provides the Pulse Control 103 with the moment by moment voltage magnitude of the AC Power Source 101 Wave thus providing Pulse Control 103 with knowledge of the moment by moment progression of the Sinusoidal Wave from AC Power Source 101 through each degree or radian of its waveform. This information permits the Pulse Control 103 to adjust the pulse width of the 4,320 Hz Higher frequency first modulated power waveform at 108 every few degrees throughout each cycle of the 50 or 60 Hz power input waveform from AC Power Source 101. This feature allows the Pulse Control 103 to control the instantaneous current throughout each cycle of AC Power Source 101 waveform and thus exert control over the harmonic currents within the AC Power Source 101 waveform.

A more detailed description of the above-described circuits is herein given beginning with the Power Source 101 and the First Stage Filter 50:

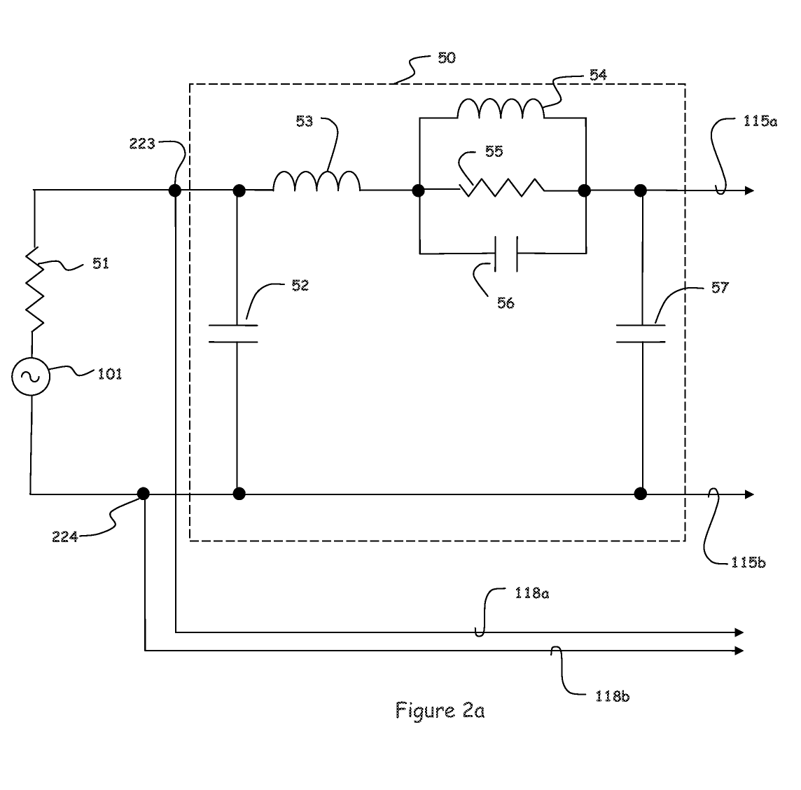

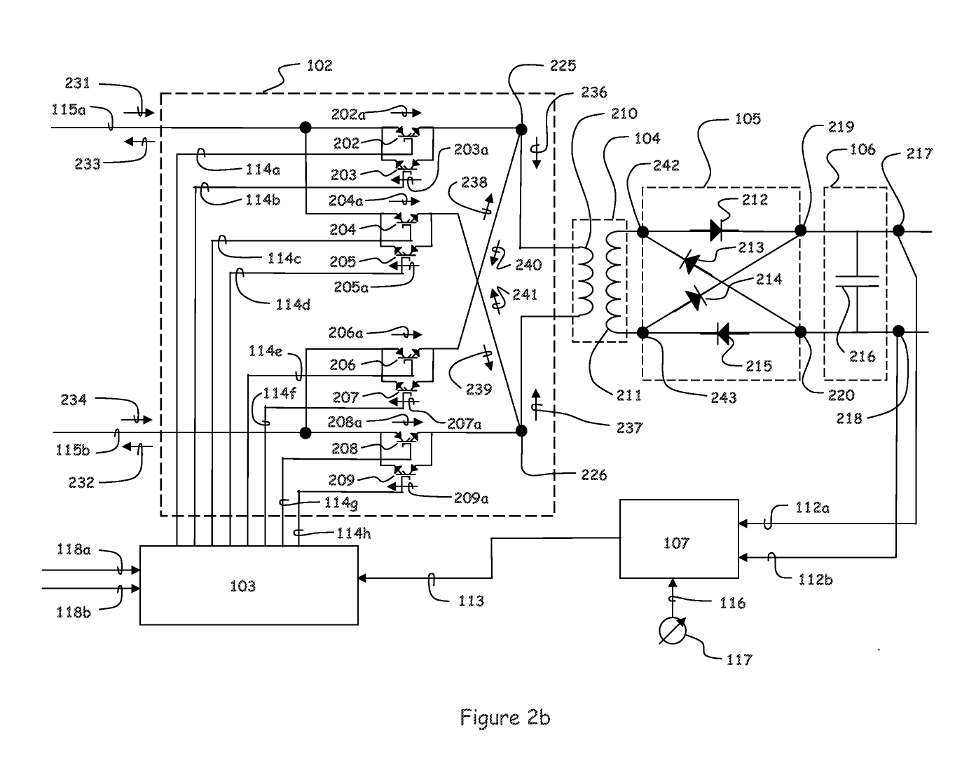

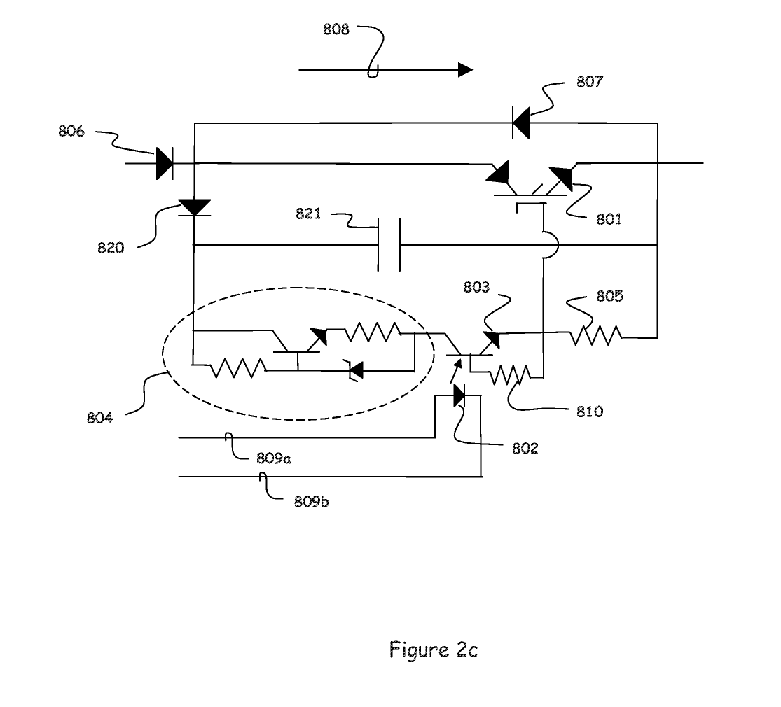

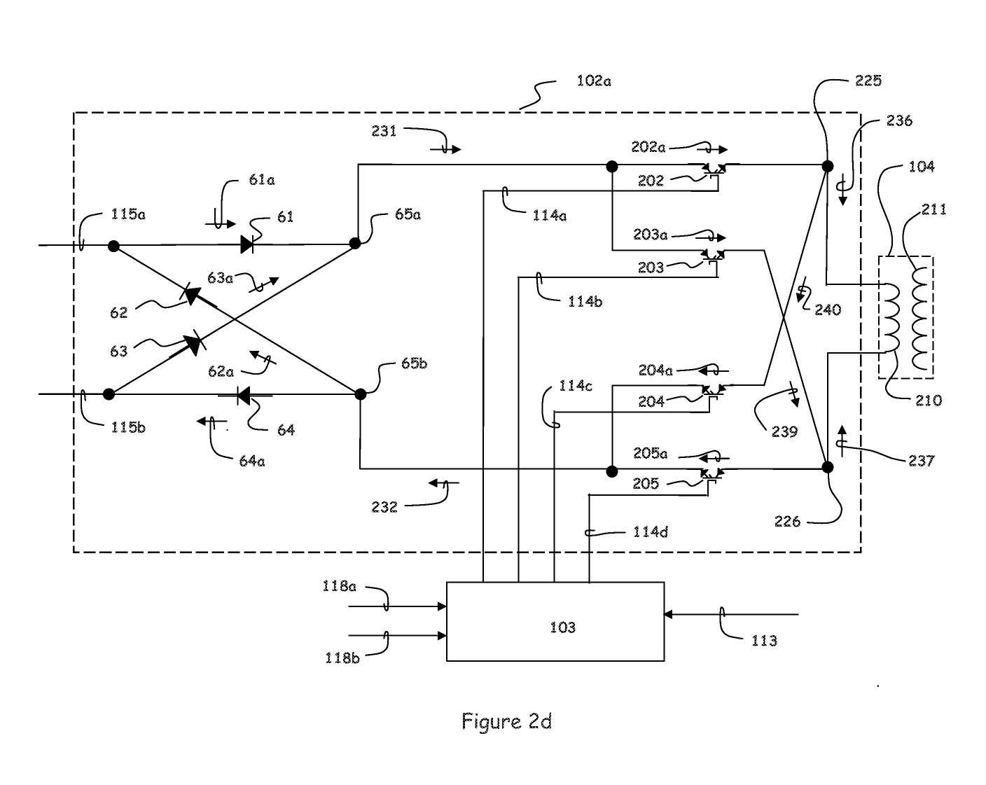

The First stage of the invention, illustrated in FIG. 2a, is the Power Source 101 and the Filter 50. The source is comprised of the AC Power Source 101 and the source resistance 51 with exemplary value of 0.345 Ohms. The Filter 50 is comprised of Capacitor 52 with exemplary value of 10 micro-Farads, Inductor 53 with exemplary value of 600 micro-Henrys, Inductor 54 with exemplary value of 135 micro-Henrys, Resistor 55 with exemplary value of 150 Ohms, Capacitor 56 with an exemplary value of 10 micro-Farads, and Capacitor 57 with exemplary value of 40 micro-Farads, for an assumed input resistance to the Modulator 102 of 3.456 Ohms. Capacitor 57 provides energy storage for each cycle of the 4,320 Hz waveform generated by the Modulator. The parallel resonate “trap” circuit comprised of Inductor 54, Resistor 55 and Capacitor 56 blocks the fundamental 4,320 Hz signal from entering the 50 or 60 Hz AC Power Source 101 conductors. The Filter 50 may include an additional parallel resonant “trap” circuit to block the second harmonic of the 4,320 Hz waveform. The second harmonic content at Capacitor 57 may be greater than the fundamental frequency 4,320 Hz due to the Modulator circuit operation. Inductor 53 and Capacitor 52 form a low-pass filter to attenuate the harmonics of the 4,320 Hz signal that might enter the AC Power Source 101 conductors. This filter design is based upon a 16.6 KW load and 240 Volt RMS input Voltage. The source impedance is assumed to be ten-percent of the Modulator load and is assumed to be resistive. The Filter 50 is designed to block the higher frequency, 4320 Hz, and its harmonics. However, the filter passes unimpeded the 50 or 60 Hz AC Power Source 101 wave to the Modulator 102 with minimal change. One skilled in the art will understand that other Filter designs may be implemented to attenuate the 4,320 Hz wave and its harmonics, as a matter of design choice.

The Second stage of the invention, illustrated in FIG. 2b, is the balanced Modulator 102 that is comprised of electronic switches 202, 203, 204, 205, 206, 207, 208, and 209. The Modulator 102 is connected to Filter 50 output conductors 115a and 115b. The Modulator 102 is connected via Filter 50 to AC Power Source 101 that is typically a 50 or 60 Hz sinusoidal voltage source. The Modulator 102 converts the AC Power Source 101 wave into the higher frequency first modulated power waveform. For this description 4,320 Hz will be used for the higher frequency but other frequencies or number of pulses or cycles per second may also be used. The electronic switches are typically eight solid state switches such as IGBT's. These eight switches are controlled by the eight pulse control connections 114a, 114b, 114c, 114d, 114e, 114f, 114g and 114h that are output from the Pulse Control 103. Each of the pulse control connections from the Pulse Control 103 to each switch may be comprised of two conductors.

FIG. 2c illustrates a circuit diagram typical for each of the eight solid state IGBT switches. This drawing illustrates IGBT 801 and the two-wire Control Connection 809a and 809b. The circuit diagram includes an opto-isolator comprised of a light emitting diode 802 coupled to an NPN photo transistor 803. The circuit diagram includes a current limiting circuit 804 connected to the collector of the NPN photo transistor 803. The circuit also includes pull-down resistors 805 and 810 connected to the IGBT gate and the NPN photo transistor base respectively. The emitter of the NPN photo transistor 803 is connected to the gate of the IGBT 801 and will turn-on the IGBT whenever current flows through Light Emitting Diode 802. Power for each circuit is provided by Diode 820 and Filter Capacitor 821. Diode 820 conducts and charges Capacitor 821 during each interval that IGBT 801 is turned off. The capacitance value of Capacitor 821 is selected to provide adequate current to operate the IGBT 801 gate drive circuit during each interval that IGBT 801 is turned on. The IGBT circuit also includes a forward conduction diode 806 and a reverse voltage breakdown protection diode 807. The forward conduction diode 806 and the reverse voltage breakdown protection diode 807 ensure that large reverse voltages do not appear across the IGBT and the photo transistor components. Arrow 808 indicates the direction of conventional current flow through the IGBT 801 circuit. The IGBT 801 circuit corresponds to each of the eight electronic switches 202, 203, 204, 205, 206, 207, 208 and 209 of FIG. 2b. The two-wire control connections 809a and 809b correspond with each of the eight pulse control connections 114a through 114h of FIG. 2b.

In FIG. 2b, the pulse control inputs 114a, 114b, 114c, 114d, 114e, 114f, 114g and 114h, to each of the eight electronic switches, control the IGBT on-off timing. This controls the width of the current pulses and the direction of current flow through Transformer 104 Primary 210 and the resultant polarity at which the voltage pulses occur at the Transformer Primary 210. FIG. 3b illustrates the voltage waveform at the primary. Control of pulse width permits regulation of the instantaneous current drawn from the AC Power Source 101. Control of pulse width also provides a means for regulation of the DC output voltage at Terminals 217 and 218. An additional technique for the control of AC Power Source 101 current and DC output Voltage is that of creating pulses consisting of several cycles of the 4,320 Hz carrier as illustrated at FIG. 3c and then varying the width of these groups of 4,320 Hz frequency waveform cycles. Carrier frequencies other than 4,320 may be used.

Pulse Control 103 receives information from Voltage Control Connection 113 and the Sinusoidal Wave Connections 118a and 118b that enables Pulse Control 103 to control the pulse width at Modulator 102 output Terminals 225 and 226 in a satisfactory manner to achieve output DC Voltage regulation and input AC current regulation. Voltage Control 107 is connected via Voltage Measurement Connections 112a and 112b to the DC output terminals 217 and 218 of Filter Capacitor 216 to measure the smoothed DC Output Voltage at Terminals 217 and 218. Terminals 217 and 218 are located on the DC Output conductors 111a and 111b shown in FIG. 1. Voltage Control 107 may also receive a Voltage Command 116 from DC Controller 117. DC Controller 117 outputs Voltage Command 116 that Voltage Control 107 then compares with the magnitude of the Smoothed DC Output Voltage. Voltage Control 107 outputs information pertaining to voltage regulation via Voltage Control Connection 113 that is sent to Pulse Control 103. Pulse Control 103 utilizes the signals from the Voltage Control Connection 113 and AC Input connections 118a and 118b to influence the signals on Pulse Control Connections 114a through 114h in a manner that regulates the value of the DC Voltage at DC output terminals 217 and 218.

The preferred means of regulating the output DC Voltage at terminals 217 and 218 is that of varying the pulse width of the positive and negative excursions of the 4,320 Hz waveform at the primary 210 of the Transformer 104. The signals on Pulse Control Connections 114a through 114h will typically control the timing and pulse width of each half cycle of the 4,320 Hz first modulated power waveform that the Modulator 102 outputs at terminals 225 and 226 into the Transformer primary winding 210. Pulse Control 103 is connected to the Power Source 101 Input Terminals 223 and 224 via connections 118a and 118b illustrated in FIG. 2a. These connections allow Pulse Control 103 to monitor the instantaneous polarity and magnitude of the AC Power Source 101 voltage. The AC Input sinusoidal voltage wave connections 118a and 118b provide the Pulse Control 103 with knowledge of the polarity of the Waveform from AC Power Source 101 at every moment in time thus permitting Pulse Control 103 to turn ON and OFF the appropriate solid state switches (IGBT's) within the Modulator 102. The AC Input sinusoidal voltage waveform connections 118a and 118b also provide the Pulse Control 103 with the moment by moment magnitude of the Waveform at Terminals 223 and 224 thus providing Pulse Control 103 with knowledge of the moment by moment progression of the AC Power Source 101 wave through each degree or radian of its waveform. This information permits the Pulse Control 103 to adjust the pulse width of the 4,320 Hz wave at the transformer primary 210 every few degrees throughout each cycle of the 50 or 60 Hz AC Power Source 101 input waveform thereby allowing the Pulse Control 103 to have control of the instantaneous current throughout each cycle of the 50 or 60 Hz AC Power Source 101 Input waveform and thus exert control over its harmonic currents.

Pulse Control 103 may also vary the on-off timing of the electronic switches in a manner that varies the carrier frequency of the pulse modulation at Transformer Primary 210. Varying the pulse frequency can provide an additional means for regulating the DC output voltage at terminals 217 and 218 wherein the Transformer may have frequency limited throughput due to inductive reactance. The inductive reactance may be designed into the transformer or provided as an external inductance or choke in the primary or secondary circuit.

The following two steps give a summary of the Modulator 102 operation beginning whenever the AC Power Source 101 provides a positive voltage at Terminal 223 with respect to Terminal 224 at the input of Filter 50. These two steps may be executed in reverse order.

Step One:

The Pulse Control 103 will output a turn on control signal to Switch 202 and Switch 209 causing currents designated by arrows 231, 202a, 236, 209a, and 232 to flow. These currents will produce a positive voltage from terminal 225 to 226 at Transformer Primary 210. The Pulse Control 103 will next output a turn off control signal to Switches 202 and 209. The duration of this pulse at Transformer Primary 210 will be about 28 micro-seconds, assuming a 25-percent duty cycle and a 4,320 Hz waveform.

Step Two:

The Pulse Control 103 will next output a turn on control signal to Switch 204 and Switch 207 causing currents designated by arrows 231, 204a, 239, 237, 240, 207a, and 232 to flow. These currents will produce a negative voltage from terminal 225 to terminal 226 at Transformer Primary 210. The Pulse Control 103 will next output a turn off control signal to Switches 204 and 207. The duration of this pulse at Transformer Primary 210 will also be about 28 micro-seconds, assuming a 25-percent duty cycle and a 4,320 Hz waveform.

This step one and step two process of producing positive and negative voltage pulses at transformer Primary 210 will repeat at a rate that produces a 4,320 Hz pulse waveform. This circuit operation will continue while the voltage at Terminal 223 is positive with respect to Terminal 224 at the input of Filter 50.

Whenever the AC Power Source 101 crosses zero voltage and provides a negative voltage at Terminal 223 with respect to Terminal 224 the following two steps summarize of the current flow. These two steps may be executed in reverse order.

Step Three:

The Pulse Control 103 will output a turn on control signal to Switch 208 and Switch 203 causing currents designated by arrows 234, 208a, 237, 203a, and 233 to flow. These currents will produce a negative voltage from Terminal 225 to Terminal 226 at Transformer Primary 210. The Pulse Control 103 will next output a turn off control signal to switches 208 and 203. The duration of this pulse at Transformer Primary 210 will be about 28 micro-seconds, assuming a 25-percent duty cycle and a 4,320 Hz waveform.

Step Four:

The Pulse Control 103 will next output a turn on control signal to Switch 206 and Switch 205 causing a current designated by arrows 234, 206a, 238, 236, 241, 205a, and 233 to flow. These currents will produce a positive voltage from Terminal 225 to Terminal 226 at Transformer Primary 210. The pulse control 103 will next output a turn off control signal to Switches 206 and 205. The duration of this pulse at Transformer Primary 210 will also be about 28 micro-seconds, assuming a 25-percent duty cycle and a 4,320 Hz waveform.

This step three and step four process of producing negative and positive voltage pulses at transformer Primary 210 will repeat at a rate that produces a 4,320 Hz pulse waveform. This circuit operation will continue while the voltage at Terminal 223 is negative with respect to the voltage at Terminal 224.

Whenever the AC Power Source 101 Voltage crosses zero voltage and again provides a positive voltage at Terminal 223 with respect to Terminal 224 the process of step one and step two described will begin again and the step one, step two, step three and step four process will continue indefinitely.

The Second Stage Modulator of the invention may alternately be configured as illustrated in FIG. 2d. This Modulator 102a is comprised of a Full wave Bridge Rectifier (diodes 61-64) and electronic switches 202, 203, 204, and 205. The Modulator 102a is connected to Filter 50 output conductors 115a and 115b. The Modulator 102a first converts the input AC waveform into a rectified waveform. The rectified waveform is illustrated at FIG. 3d. The Modulator 102a then converts the rectified wave into a higher frequency modulated power waveform. For this description 4,320 Hz will be used for the higher frequency but other frequencies or number of pulses or cycles per second may also be used. Diodes 61, 62, 63 and 64 are connected in a full-wave, bridge rectifier circuit. The rectified waveform at terminals 65a and 65b is illustrated at FIG. 3d. The electronic switches 202, 203, 204, and 205 are typically four solid state switches such as IGBT's. These four switches 202, 203, 204, and 205 are controlled by the four pulse control Connections 114a, 114b, 114c and 114d that are output from the Pulse Control 103. Each of the pulse control Connections from the Pulse Control 103 to each switch may be comprised of two conductors.

FIG. 2c illustrates a circuit diagram typical for each of the four solid state IGBT switches 202, 203, 204, and 205. This drawing illustrates an IGBT 801 and the two-wire Control Connection 809a and 809b. This circuit operates as described previously. The IGBT 801 circuit corresponds to each of the four electronic switches 202, 203, 204 and 205 of FIG. 2d. The two-wire control Connection 809a and 809b correspond with each of the four pulse control Connections 114a through 114d of FIG. 2d.

In FIG. 2d, the pulse control inputs 114a, 114b, 114c and 114d to each of the four electronic switches, control the IGBT on-off timing. This controls the width of the current pulses and the direction of current flow through Transformer 104 Primary 210 and the resultant polarity at which the voltage pulses occur at the Transformer 104 Primary 210.

The following two steps give a summary of the modulator 102a operation beginning whenever the AC Power Source 101 provides a positive voltage at Terminal 223 with respect to Terminal 224 at the input of Filter 50. These two steps may be executed in reverse order. Modulator 102a is illustrated in FIG. 2d.

Step One:

The Pulse Control 103 will output a turn on control signal to Switch 202 and Switch 205 causing currents designated by arrows 61a, 231, 202a, 236, 205a, 232 and 64a to flow. These currents will produce a positive voltage from terminal 225 to 226 at Transformer 104 Primary 210. The Pulse Control 103 will next output a turn off control signal to Switches 202 and 205. The duration of the positive pulse across Transformer 104 primary 210 will be about 28 micro-seconds, assuming a 25-percent duty cycle and a 4,320 Hz waveform.

Step Two:

The Pulse Control 103 will next output a turn on control signal to Switch 203 and Switch 204 causing currents designated by arrows 61a, 231, 203a, 239, 237, 240, 204a, 232 and 64a to flow. These currents will produce a negative voltage from terminal 225 to terminal 226 at Transformer Primary 210. The Pulse Control 103 will next output a turn off control signal to Switches 203 and 204. The duration of the negative pulse across Transformer 104 primary 210 will also be about 28 micro-seconds, assuming a 25-percent duty cycle and a 4,320 Hz waveform.

This step one and step two process of producing positive and negative voltage pulses at Transformer 104 Primary 210 will repeat at a rate that produces a 4,320 Hz pulse waveform. This circuit operation will continue while the voltage at Terminal 223 is positive with respect to Terminal 224 at the input of Filter 50.

Whenever the AC Power Source 101 crosses zero voltage and provides a negative voltage at Terminal 223 with respect to Terminal 224 the following two steps summarize of the current flow. These two steps may be executed in reverse order.

Step Three:

The Pulse Control 103 will output a turn on control signal to Switch 203 and Switch 204 causing currents designated by arrows 63a, 231, 203a, 239, 237, 240, 204a, 232 and 62a to flow. These currents will produce a negative voltage from Terminal 225 to Terminal 226 at Transformer 104 Primary 210. The Pulse Control 103 will next output a turn off control signal to switches 203 and 204. The duration of this pulse at Transformer Primary 210 will be about 28 micro-seconds, assuming a 25-percent duty cycle and a 4,320 Hz waveform.

Step Four:

The Pulse Control 103 will next output a turn on control signal to Switch 202 and Switch 205 causing a current designated by arrows 63a, 231, 202a, 236, 205a, 232 and 62a to flow. These currents will produce a positive voltage from Terminal 225 to Terminal 226 at Transformer 104 Primary 210. The pulse control 103 will next output a turn off control signal to Switches 202 and 205. The duration of this pulse at Transformer Primary 210 will also be about 28 micro-seconds, assuming a 25-percent duty cycle and a 4,320 Hz waveform.

This step three and step four process of producing negative and positive voltage pulses at transformer Primary 210 will repeat at a rate that produces a 4,320 Hz pulse waveform. This circuit operation will continue while the voltage at Terminal 223 is negative with respect to the voltage at Terminal 224 at the input of Filter 50.

Whenever the AC Power Source 101 Voltage crosses zero voltage and again provides a positive voltage at Terminal 223 with respect to Terminal 224 the process of step one and step two described will begin again and the step one, step two, step three and step four process will continue indefinitely.

In summary, the Second stage of the invention is a balanced modulator 102 or 102a with control circuits from Pulse Control 103 that convert the 50 or 60 Hz power waveform 101 into a higher frequency waveform at the Transformer 104 Primary 210. It is noted that for the current paths of the modulator circuit illustrated in FIG. 2d, each path contains forward junction voltage drops for two diodes and two IGBT's whereas the current paths for the modulator circuit illustrated at FIG. 2b contain forward junction voltage drops for only two IGBT devices. It is also noted that each IGBT in FIG. 2d operates twice as often as each IGBT in FIG. 2b thereby each IGBT of FIG. 2d requires twice the power dissipation rating as those illustrated in FIG. 2b.

The Third stage is comprised of a Transformer 104. This Transformer 104 operates at a frequency of 4,320 Hz and will, therefore, require less core material and less copper for the windings than a 50 or 60 Hz transformer of equal Volt-Ampere rating. The frequency response of the transformer should accommodate the Modulator output pulses at 4,320 Hz. The transformer losses for a particular core material may increase with frequency and therefore must also be considered in the transformer design used in this application.

In a preferred embodiment, the secondary-to-primary turns ratio for Transformer 104 will be selected so that the zero-to-peak transformer secondary open circuit Voltage is four times the desired DC output Voltage. The DC output Voltage is therefore regulated by means of pulse width modulation, to equal one-fourth the maximum zero to-peak, open-circuit voltage of the transformer secondary. Other ratios of the open-circuit to DC Output Voltage may be used and other transformer secondary-to-primary ratios may be used. The Primary 210 of Transformer 104 is connected to terminals 225 and 226 located at the output from the Modulator 102 or 102a. A snubber circuit may be connected between the primary winding terminals of the Transformer 104 to reduce the magnitude of voltage transients and thus protect the IGBT devices.

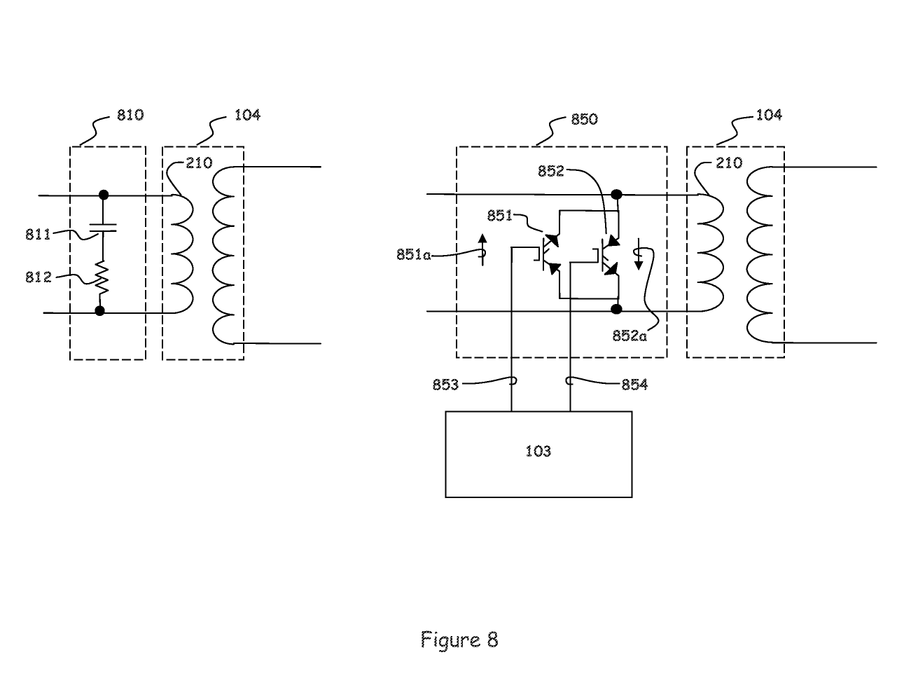

FIG. 8 illustrates both a passive RC Snubber 810 and an active Snubber 850. Passive Snubber 810 is comprised of Capacitor 811 and Resistor 812 connected in series across the Transformer 104 Primary winding 210. The Passive Snubber RC circuit absorbs the current flow from the energy stored within Transformer 104 Primary winding 210 whenever the Modulator 102 Switches 202, 203, 204, 205, 206, 207, 208 and 209 are turned OFF or whenever the Modulator 102a Switches 202, 203, 204 and 205 are turned OFF. Active Snubber 850 is comprised of Switch 851 and Switch 852 which are connected in parallel across the Transformer 104 Primary winding 210. Switch 851 and Switch 852 may be IGBT devices. Switch 851 and Switch 852 are connected to permit current flow in opposite directions as indicated by the arrows 851a and 852a. The gate of Switch 851 is connected to Pulse Control 103 via Pulse Control Connections 853 and the gate of Switch 852 is connected to Pulse Control 103 via Pulse Control Connections 854. The Pulse Control 103 will apply a turn off signal to Switch 851 and Switch 852 whenever any of the Switches within Modulator 102 are conducting or whenever any of the Switches of Modulator 102a are conducting. The Pulse Control 103 will apply a turn on signal to Switch 851 and Switch 852 whenever all the Switches within Modulator 102 are turned OFF or whenever all of the Switches of Modulator 102a are turned OFF. The Active Snubber circuit will absorb the current flow from the energy stored within Transformer 104 Primary Winding 210 whenever the Modulator 102 Switches 202, 203, 204, 205, 206, 207, 208 and 209 are turned OFF or whenever the Modulator 102a Switches 202, 203, 204 and 205 are turned OFF.

Referring now to FIG. 2b, the Secondary 211 of Transformer 104 is connected to terminals 242 and 243 located at the input of the Rectifier 105 circuit. To achieve higher power levels, Transformer 104 may be implemented using two or more transformers with their windings either in parallel or in series. Typically these transformers would be of equal KVA rating. For parallel connected transformers of equal rating, the series reactance of each should be equal in order to balance the currents.

The higher frequency 4,320 Hz waveform from the Modulator output is input to the Transformer Primary winding 210. The higher frequency waveform is output from the Transformer secondary winding 211 which is connected to terminals 242 and 243. The transformer secondary circuit may contain a series inductive reactance either internal to the transformer or as a separate component. The value of this reactance may be chosen to limit the maximum Secondary 211 current.

The Fourth stage is comprised of a full-wave Rectifier circuit 105. This Rectifier is illustrated in detail at FIG. 2b as a four terminal bridge rectifier circuit comprised of diodes 212, 213, 214 and 215. Other rectifier circuits may be used. The Secondary 211 of the Transformer 104 is connected to the input terminals 242 and 243 of the Rectifier 105. The Rectifier circuit 105 converts the higher frequency AC into a full-wave rectified DC Voltage at the Rectifier 105 output terminals 219 and 220. The rectified DC Voltage at terminals 219 and 220 will generally contain current and voltage ripples that require filtering. The output terminals 219 and 220 of the Rectifier 105 are connected to a Filter circuit 106. The Filter circuit 106 comprises a filter capacitor 216 which should be a capacitive input type with no additional series impedance between the Filter 106 input and the Rectifier 105 output to ensure that the peak reverse voltage across the Diodes 212, 213, 214 and 215 does not exceed the DC Voltage across the Filter input Capacitor 216.

The Fifth stage is the Filter circuit 106. FIG. 2b illustrates the filter as a simple Capacitor 216. The Filter may also be comprised of one or more filter capacitors and choke coils generally arranged as a Capacitor input low-pass filter network. The Filtered DC Voltage will be output from Terminals 217 and 218. In the preferred embodiment, the Filter 106 has an input Capacitor 216 with sufficient capacity to essentially eliminate voltage ripples. The use of a capacitor input filter will significantly reduce and minimize the peak reverse voltages across the rectifier diodes 212, 213, 214 and 215.

FIG. 3a illustrates an oscillograph that represents one cycle of a 50 or 60 Hz AC Power Source 101 input voltage to the Filter 50 and to the Modulator 102. This Voltage appears at terminals 223 and 224 of FIG. 2a and at Connections 115a and 115b of FIG. 2b and FIG. 2d. FIG. 3b illustrates the pulse modulated, Higher Frequency 4,320 Hz, first modulated power waveform at the Modulator output Terminals 225 and 226 and at the Transformer Primary 210. The first pulse modulated power waveform is preferably a double-sideband suppressed carrier waveform. In a preferred design, the Pulse Control 103 and Modulator 102 or 102a will create a 4,320 Hz waveform in which both the 4,320 carrier and the 50 or 60 Hz power waveform are suppressed at the Transformer 104 Primary winding 210. The resultant first modulated power waveform at the Transformer 104 Primary winding 210 may be expressed as: Sine A×Sine B=½ [−Cosine (A+B)+Cosine (A−B)], where A=2×Pi×60 radians/second, the power waveform, and where B=2×Pi×4,320 radians/second, the carrier waveform.

It is noted that the expression on the right of the equation contains neither a Cosine A term nor a Cosine B term. Thus, both the 4,320 Hz carrier and the 60 Hz power wave are suppressed. Although a coherent 4,320 Hz waveform is desirable, it is not essential and therefore complete suppression of the 4,320 Hz carrier and the 50 or 60 Hz power waves may not be achieved.

Note that in this equation the 4,320 Hz modulating carrier, Sine B, is expressed as a simple sinusoidal wave. In reality, this 4,320 Hz modulating carrier will typically be a pulse waveform that contains frequency sidebands above and below the 4,320 Hz carrier frequency. Although these sidebands are present, they will not invalidate the conclusion that the 4,320 Hz carrier frequency and the 60 Hz power waveform will normally be suppressed at the Transformer Primary 210.

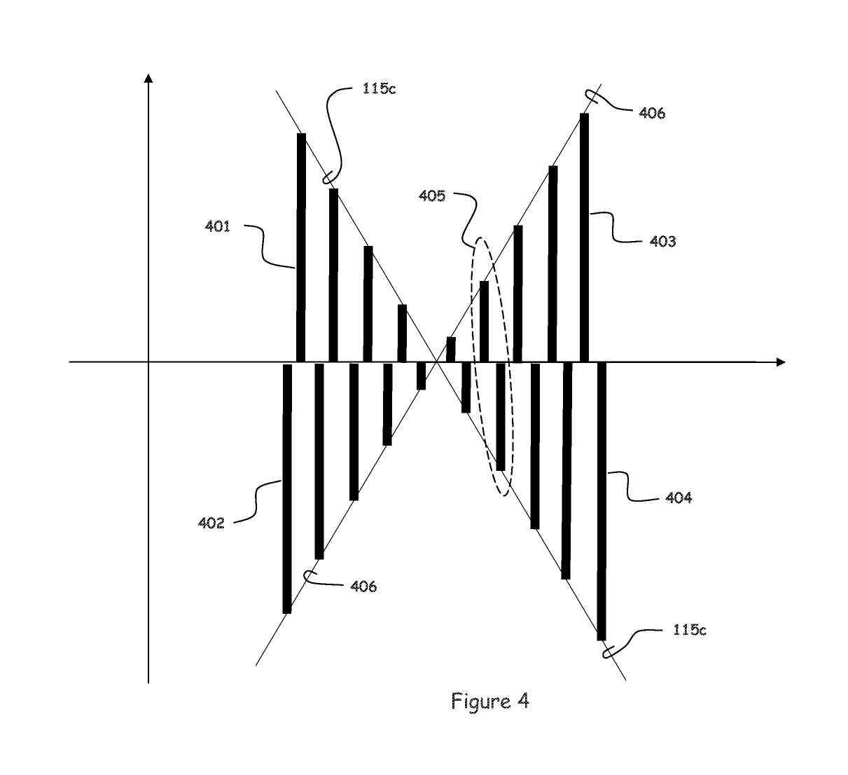

FIG. 4 presents an enlarged view of the 4,320 Hz waveform from FIG. 3b at the zero-crossing of the 50 or 60 Hz AC Power Source 101 waveform. FIG. 4 illustrates the Current Pulses 401, 402, 403, and 404 that appear at Transformer 104 Primary 210. These current pulses are related to the current paths within Modulator 102 as illustrated at FIG. 2b. Current Pulses 401 are created by current paths 231, 202a, 236, 209a, and 232. Current pulses 402 are created by current paths 231, 204a, 239, 237, 240, 207a, and 232. Current Pulses 404 are created by current paths 234, 208a, 237, 203a, and 233. Current Pulses 403 are created by current paths 234, 206a, 238, 236, 241, 205a, and 233. The current pulses 401, 402, 403 and 404 are also related to the current paths for Modulator 102a as illustrated at FIG. 2d.

The resultant first modulated power waveform, illustrated at FIG. 4, at the Transformer Primary 210 is comprised of the pulses bounded by the 50 or 60 Hz input Source Voltage wave 115c and the negative image of this wave 406. This enlarged view also illustrates one cycle or period 405 of the 4,320 Hz higher frequency waveform. Note that the pulses are rectangular due to the fast turn-on and a fast turn-off switching of the IGBT switching devices. Fast switching is important for minimizing power dissipation in the IGBT devices.

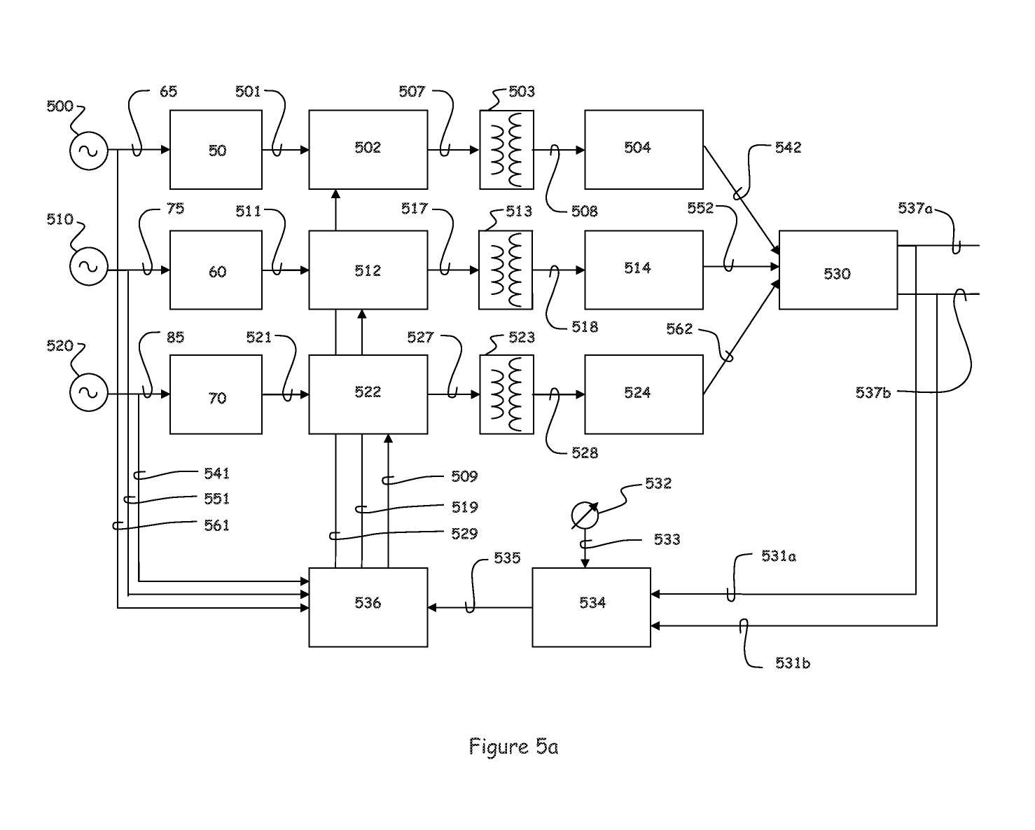

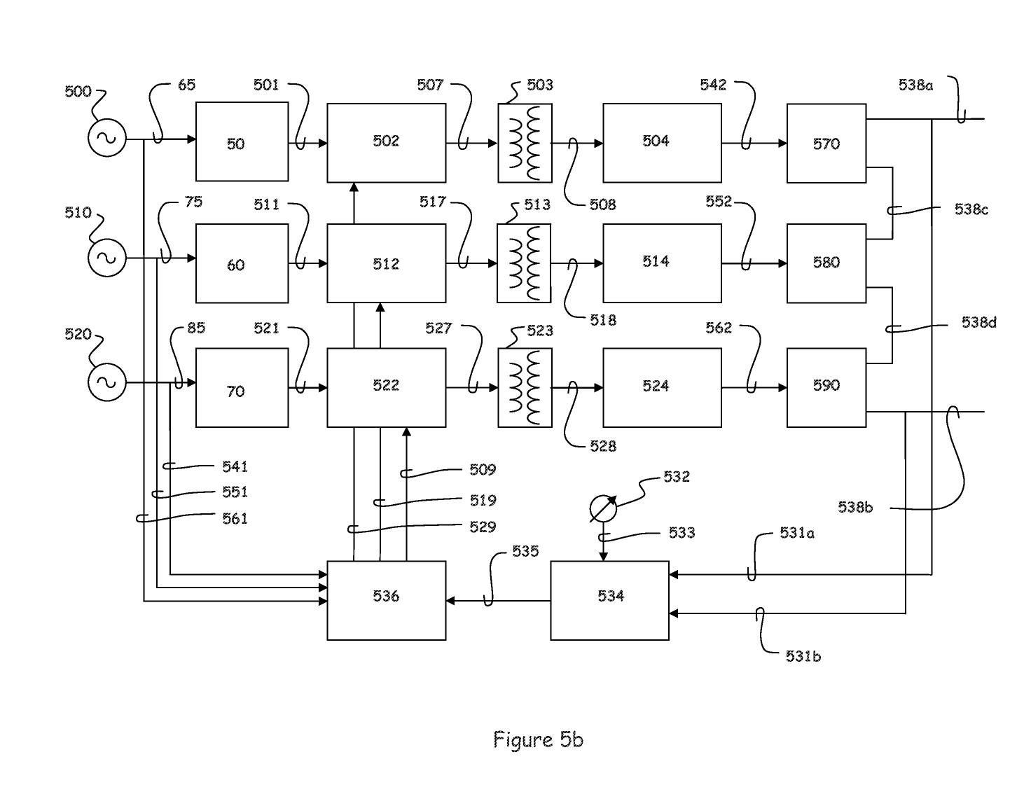

For applications where the power source 101 is Three-Phase AC, a three-phase AC configuration of the invention circuit is illustrated at FIGS. 5a and 5b. The three-phase AC configuration joins together three single-phase AC to DC Power Supply Circuits, of the configuration illustrated at FIG. 1 and FIGS. 2a, 2b and 2c, wherein each phase of a Three-Phase AC Power Source is connected to the Filter input of one of the three AC to DC Power Supply Circuits. The circuits in FIG. 5a and FIG. 5b differ primarily in the manner that the rectifiers 504, 514 and 524 are interconnected.

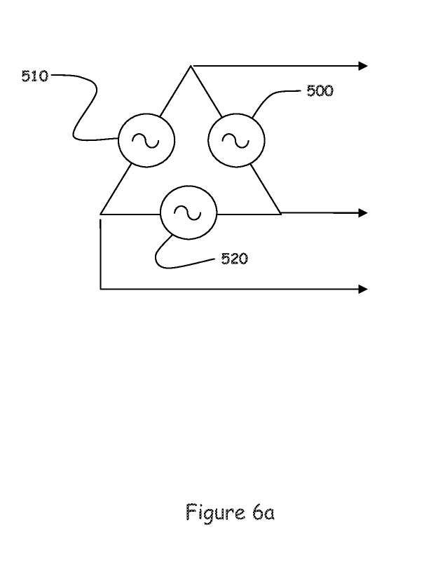

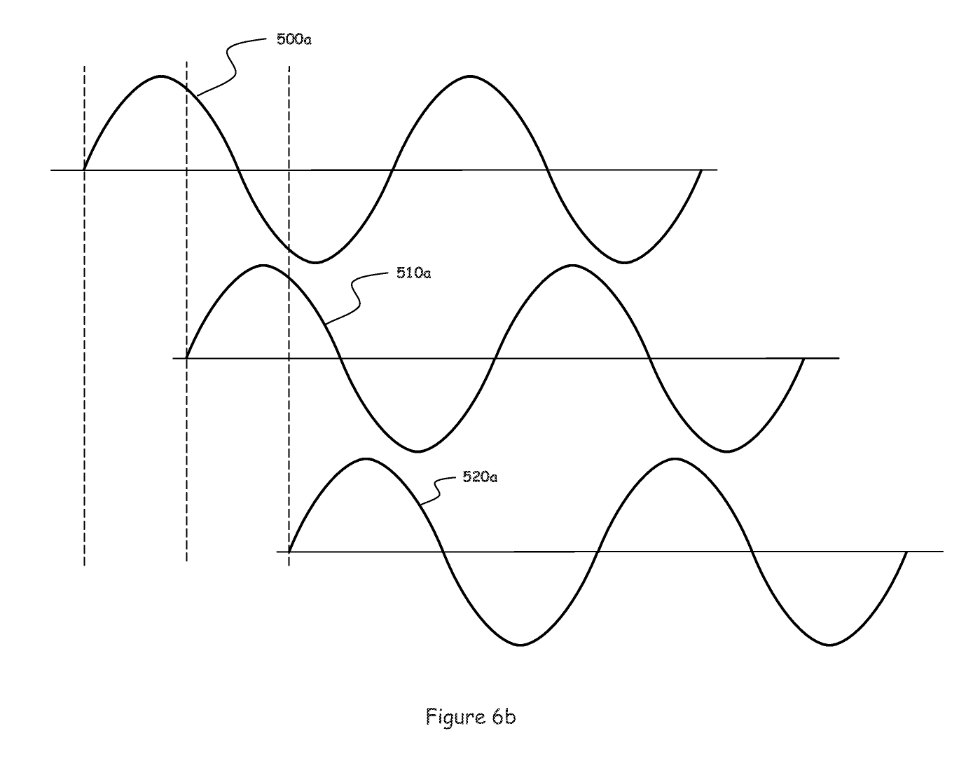

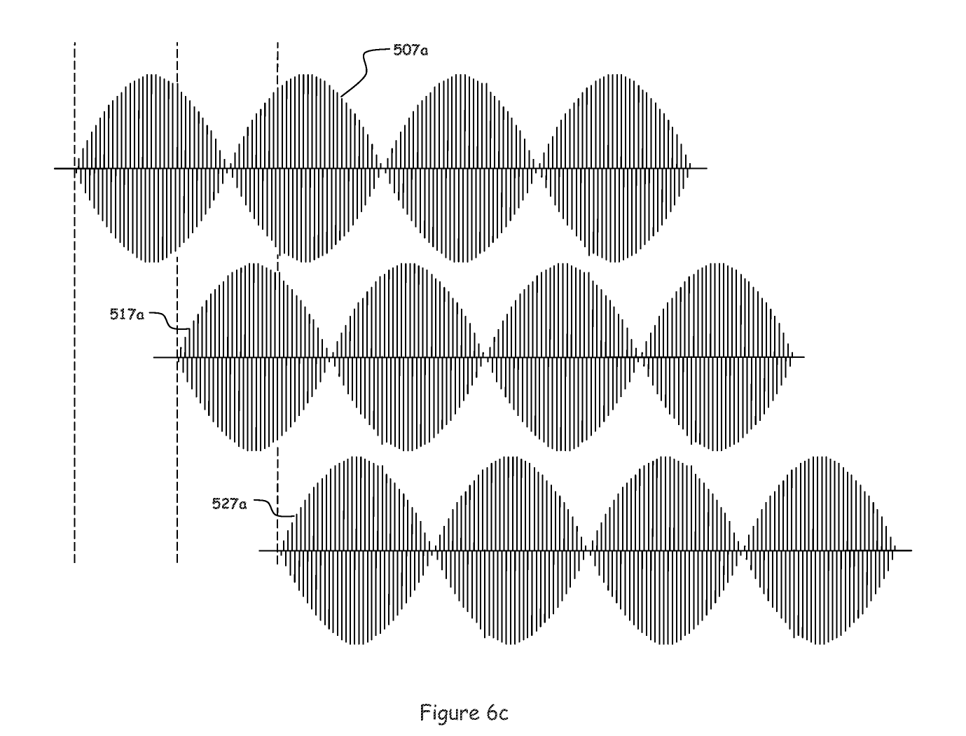

A Three-Phase AC Power Source is illustrated at FIG. 6a. This source is Delta connected and is comprised of AC Power Source 500, AC Power Source 510 and AC Power Source 520.

The first stages of the Three-Phase AC to DC Power Supply configurations are comprised of Input Filters 50, 60 and 70 that are connected to AC Power Sources 500, 510 and 520 respectively. The AC Power Sources 500, 510 and 520 output Sinusoidal Waves that are typically 50 or 60 Hz. Each of the three Sinusoidal Waves typically has a 120 degree phase shift with respect to the other two. FIG. 6b illustrates the Sinusoidal Waves 500a, 510a and 520a that are on Connections 65, 75 and 85 respectively and that are from their respective AC Power Sources 500, 510 and 520.

The Second stages of the Three-Phase AC to DC Power Supply configurations are comprised of Modulators 502, 512 and 522 that are connected to Input Filters 50, 60 and 70 respectively. FIG. 6b illustrates the Sinusoidal Waves 500a, 510a and 520a that are on Connections 501, 511 and 521 respectively and that are input to their respective Modulators 502, 512 and 522 via Filters 50, 60 and 70. Modulators 502, 512 and 522 modulate the waveforms at 501, 511 and 521 into higher frequency first modulated power waveforms at Connections 507, 517 and 527. FIG. 6c illustrates the higher frequency first modulated power waveforms 507a, 517a and 527a at Connections 507, 517 and 527 respectively. The Modulators 502, 512 and 522 are each preferably configured as balanced modulators. For this description 4,320 Hz will be used for the higher carrier frequency but other frequencies or number of pulses or cycles per second may also be used. The Modulators 502, 512 and 522 are controlled by Pulse Control 536 via Pulse Control Connections 509, 519 and 529. The Pulse Control 536 via Pulse Control Connections 509, 519 and 529, controls the frequency or timing at which the pulses of the first modulated power waveforms 507a, 517a and 527a occur and also controls the duration or width of each pulse of the first modulated power waveforms 507a, 517a and 527a output from the Modulators 502, 512 and 522.

In a preferred embodiment, the Pulse Control 536 establishes the timing of the signals at 509, 519 and 529 to the Modulators such that the first modulated power waveforms at 507, 517 and 527 each form a power waveform with a suppressed carrier frequency of 4,320 Hz. In this design configuration the three 4,320 Hz suppressed Carrier Waves within the first modulated power waveforms of 507a, 517a and 527a may have the same relative phase with respect to each other.

The Third stages are comprised of Transformers 503, 513 and 523. The primaries of these Transformers are connected to the first modulated power waveforms 507a, 517a and 527a output from the Modulators 502, 512 and 522. The design of Transformers 503, 513 and 523 is based upon the higher operating frequency of 4,320 Hz and thus the Transformers may be significantly smaller than a typical 50 Hz or 60 Hz transformer with the same Volt-Ampere rating. The outputs from the Transformers 503, 513 and 523, are the second modulated power waveforms at Connections 508, 518 and 528. The maximum zero-to-peak value of the open-circuit second modulated power waveforms on Connections 508, 518 and 528 is preferably four times the desired DC output Voltage at the rectifier DC output. Other ratios of maximum zero-to-peak value of the open-circuit secondary voltage to rectifier DC output voltage may be used.

The Fourth stages are comprised of Rectifiers 504, 514 and 524. The rectifiers are typically full-wave bridge rectifiers. The Transformer second modulated power waveforms at Connections 508, 518 and 528 from the secondary windings of Transformers 503, 513 and 523 are connected to the input of the Rectifiers 504, 514 and 524. Rectifiers 504, 514 and 524 convert the second modulated power waveforms at Connections 508, 518 and 528 into full wave rectified waveforms at Connections 542, 552 and 562. The rectified waveforms will generally contain current and voltage ripples that require filtering.

The Fifth stage, illustrated in FIG. 5a, is a Filter 530. This circuit represents a parallel DC output configuration. Rectified waveforms on Connections 542, 552 and 562 are input to the Filter 530. The rectifier DC outputs are preferably connected together in parallel and are input to a common Filter 530. The Filter 530 may be comprised of a single capacitor or one or more filter capacitors and choke coils typically arranged in a Capacitor input low-pass filter circuit. The Filter 530 reduces the voltage ripples in the rectified waveforms on Connections 542, 552 and 562 and outputs a Smoothed DC Voltage at output conductors 537a and 537b. The size of the circuit components in the filter for a 4,320 Hz rectified waveform may be much smaller than those required to filter a rectified 50 Hz or 60 Hz waveform.

The Fifth Stage illustrated in FIG. 5b illustrates a three-phase AC configuration for the invention in which the three Rectifier outputs at Connections 542, 552 and 562 are connected together in a series circuit configuration. In this configuration, the three Filters, 570, 580 and 590 are connected together in series by conductors 538c and 538d. This series output will have a single DC output at output conductors 538a and 538b. It is feasible to connect the three filters in series since each of the rectified voltages on Connections 542, 552 and 562 is floating and isolated from each other and from ground. The isolation is made possible by the Transformers 503, 513 and 523.

A Voltage Control 534 is connected via Voltage Measurement Connections 531a and 531b to measure the Smoothed DC Voltage at the output conductors 537a and 537b for the parallel output circuit and at the output conductors 538a and 538b for the series output filter configuration. Voltage Control 534 may also receive a Voltage Command 533 from DC Controller 532. DC Controller 532 outputs Voltage Command 533 that is used to influence the magnitude of the Smoothed DC Voltage at output conductors 537a and 537b for a parallel DC output or at output conductors 538a and 538b for a series DC output. Voltage Control 534 outputs information pertaining to voltage regulation via Voltage Control Connection 535 to an input of Pulse Control 536. Pulse Control 536 may utilize the information from the Voltage Control Connection 535 to influence the pulse signal information being sent to the Modulators 502, 512 and 522 via Pulse Control Connections 509, 519 and 529 in order to regulate the timing and duration of the high frequency pulses at Connections 507, 517, and 527. In addition, Pulse Control 536 may also utilize the AC Power Sources 500, 510 and 520 Voltage Waves input via the sinusoidal wave connections 541, 551 and 561 to influence the signals on Pulse Control Connections 509, 519 and 529. Connections 541, 551, and 561 provide the Pulse Control 536 with polarity and magnitude information for the AC power waveforms 500a, 510a and 520a illustrated at FIG. 6b. The magnitude information may be used to regulate the instantaneous current drawn from the AC Power Sources 500, 510 and 520 as a function of the instantaneous values of the input voltages. The polarity information from AC Power Sources 500, 510 and 520 is used to select the appropriate semiconductor switches and current paths within the Modulators 502, 512 and 522.

### SUMMARY

It should now be apparent that the above-described invention provides an important benefit in that the AC to DC Power Supply design reduces harmonic currents in the 50 or 60 Hz AC Power Source when compared with conventional AC to DC Rectifier Circuits. The following description is based upon a single-phase power source but the results also are applicable to three-phase circuit configurations.

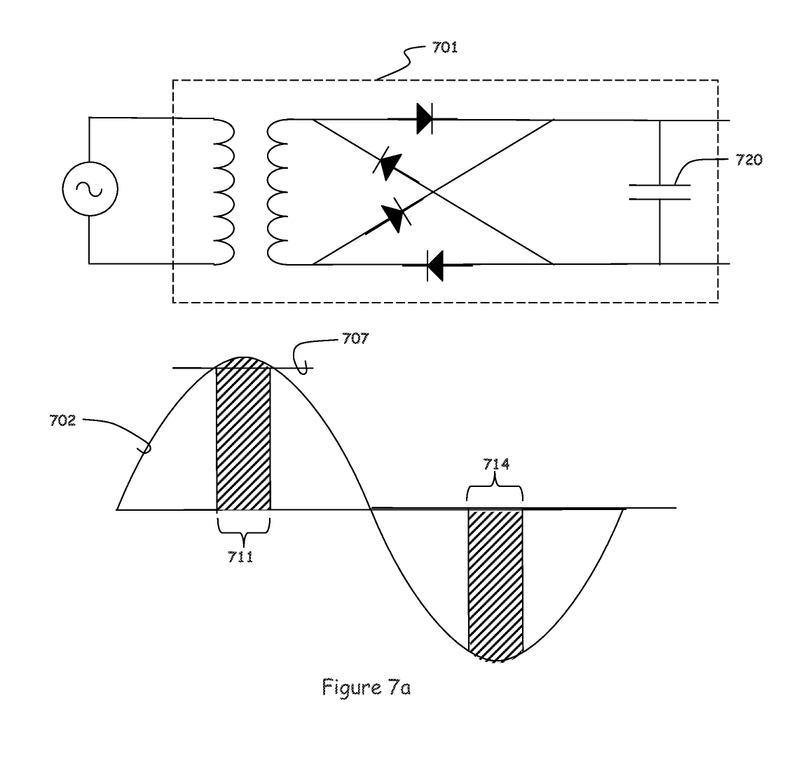

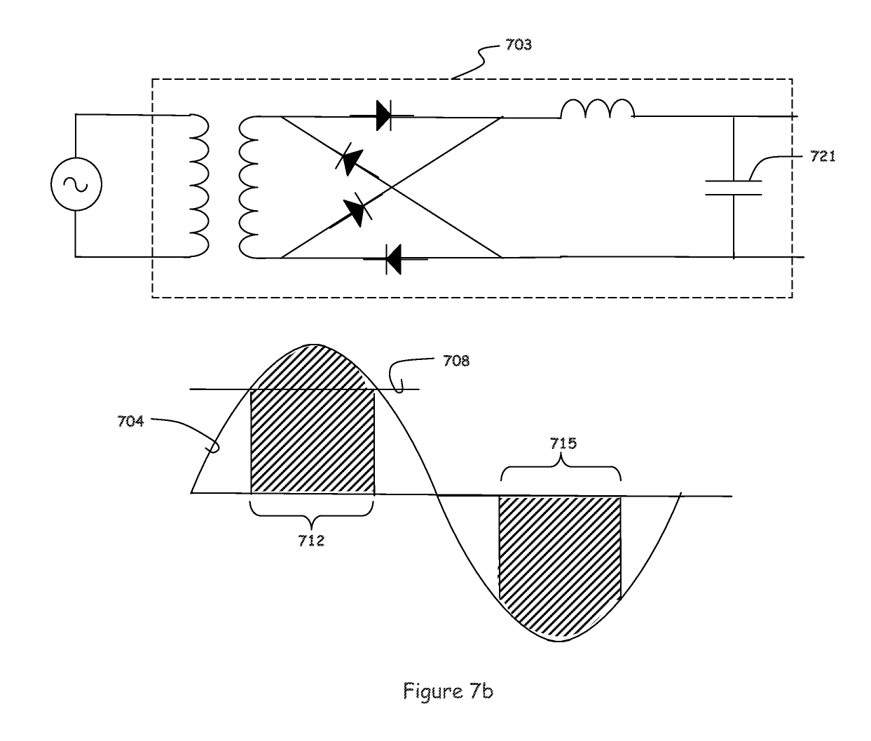

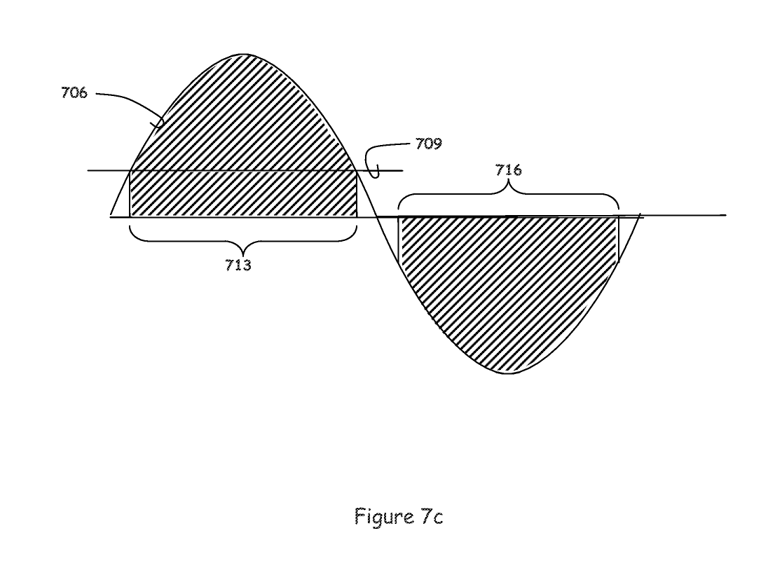

FIGS. 7a and 7b illustrate conventional Rectifier Circuits 701 and 703. FIGS. 7a and 7b also illustrate the respective input power AC Voltage Waveforms 702 and 704 associated with the two Rectifiers 701, 703. The Line 707 in FIG. 7a represents the DC voltage across the Capacitor 720. The Line 708 in FIG. 7b represents the DC Voltage across the Capacitor 721. Current will conduct from the source for each rectifier whenever the value of the AC Voltage wave is greater than the DC Voltage across the Capacitors 720 and 721. The AC Voltage waveforms have been shaded to illustrate the approximate portion of each waveform during which current flows from the AC Power Source input to each Rectifier 701, 703.

The Conventional Rectifier 701 with a simple capacitor filter typically conducts current over a relatively small portion of the AC Voltage waveform 702. For this type circuit, the value of the transformer series reactance is usually small and provides about 5-percent voltage drop at full load and the value of the capacitor is chosen to minimize the voltage ripples. The DC Output Voltage 707 is slightly less than the open-circuit, zero to peak AC Voltage at the Transformer secondary winding. For this circuit it is assumed that current conduction 711 during the positive portion of the waveform begins at about 70 degrees from the positive slope zero crossing and continues to about 110 degrees and similarly during the negative portion of the waveform. For the negative portion, current conduction 714 begins at approximately 250 degrees, which is 70 degrees from the negative slope zero crossing and continues to approximately 290 degrees.

Conventional Rectifier 703, with an “LC” filter circuit has an inductive reactance in series with the rectifier output which gives a series voltage drop and results in less DC Voltage across the Capacitor 721. This rectifier circuit conducts current over a larger portion of the AC Voltage waveform 704. Current conduction 712 during the positive portion of the waveform begins at about 39 degrees and continues to about 141 degrees and similarly during the negative portion of the waveform. For the negative portion, current conduction 715 begins at approximately 219 degrees and continues to approximately 321 degrees. Typically, the value of inductance is selected so that the DC Voltage across Capacitor 721 is equal to the average value of the open-circuit transformer secondary full-wave rectified Voltage. The Average Value equals 0.63×(peak rectified voltage).

FIGS. 2a and 2b illustrate a single-phase rectifier of a design as described for this invention. For this rectifier, we assume that the DC output Voltage is one-fourth the open-circuit, zero-to-peak Voltage of the 50 or 60 Hz envelope at the transformer secondary 4,320 Hz waveform. The envelope of the 4,320 Hz waveform is illustrated at FIG. 3b. FIG. 7c illustrates Waveform 706 which represents the 50 or 60 Hz Voltage and current conduction waveform from the AC Power Source 101 at terminals 223 and 224 at FIG. 2a for this circuit. This rectifier circuit conducts current over most of the AC Voltage waveform 706 beginning at 25-percent of the zero-to-peak value. Current conduction 713 during the positive portion of the AC Power waveform begins at about 15 degrees and continues to 165 degrees. Fifteen degrees equals Arcsine (0.25). Similarly, during the negative portion of the waveform, conduction 716 begins at approximately 195 degrees and continues to approximately 345 degrees. For this type circuit, the DC Output Voltage 709 is preferably regulated, via pulse width control, to equal one-fourth the zero-to-peak, open-circuit voltage value of the high frequency waveform at the Transformer Secondary 211.

The percent harmonic current distortion for the current conduction within Waveform 706 is relatively low. Current is conducted during the 713 and the 716 portions of the sinusoidal power waveform. Current is conducted during 83-percent of each cycle of the input Voltage. In general, the greater the conduction time each cycle, the less harmonic distortion is created.

The percent harmonic current distortion for conventional rectifier 703 and its 50 or 60 Hz AC Waveform 704 is somewhat higher. Current for this rectifier is conducted during the 712 and the 715 portions of the sinusoidal power waveform. Current for this rectifier is conducted during 56-percent of each cycle of the input Voltage waveform.

The percent harmonic current distortion for conventional rectifier 701 and its 50 Hz or 60 Hz AC Waveform 702 is larger than the others because of the short periods of current conduction. Current is conducted during the 711 and the 714 portions of the sinusoidal power waveform. Current for this rectifier is only conducted during 11-percent of each cycle of the input Voltage thus creating greater harmonic distortion within the power source currents.

It should be understood that various changes may be made in the form, details, arrangement and proportions of the components. Such changes do not depart from the scope of the invention which comprises the matter shown and described herein and set forth in the appended claims.

What is claimed is:

1. An apparatus for the conversion of AC power to DC power, comprising:
an AC power source input for connection of AC power of a first frequency;
a modulator connected to said AC power source input for modulating the AC power into a first modulated power waveform having a second frequency that is greater than said first frequency;
a transformer connected to said modulator for transforming said first modulated power waveform into a second modulated power waveform;
a rectifier connected to said transformer for rectifying said second modulated power waveform into a rectified DC waveform;
A DC power output for outputting said rectified DC waveform.

2. An apparatus as in claim 1 wherein the transformer is a step-up transformer.

3. An apparatus as in claim 1 wherein the transformer is an isolation transformer.

4. An apparatus as in claim 1 further comprising a filter connected between the rectifier and the DC power Output.

5. An apparatus as in claim 1 further comprising a filter connected between the AC Power source input and the modulator.

6. An apparatus as in claim 1 wherein said modulator performs pulse width modulation to produce said first modulated power waveform.

7. An apparatus as in claim 1 wherein the modulator performs frequency modulation to said first modulated power waveform having said second frequency.

8. An apparatus as in claim 1 wherein the second frequency is at least ten times greater than the first frequency.

9. An apparatus as in claim 1 wherein the second frequency is comprised of at least nine positive voltage pulses and at least nine negative voltage pulses per cycle of the first frequency.

10. An apparatus as in claim 6 wherein the modulator performs variable frequency pulse width modulation.

11. An apparatus as in claim 1 wherein the modulator performs the product of said AC Power Wave of said first frequency and a carrier wave having said second frequency.

12. An apparatus as in claim 7 wherein the variable frequency pulse modulation is performed to reduce the harmonic currents caused on the power source conductors.

13. An apparatus as in claim 1 wherein the AC power source input is a three-phase source.

14. An apparatus as in claim 1 wherein the modulator comprises at least one semiconductor switch.

15. An apparatus as in claim 14 wherein the modulator comprises an opto-isolator.

16. An apparatus as in claim 15 wherein the modulator comprises a light emitting diode (LED).

17. An apparatus as in claim 1 wherein the modulator performs the product of a carrier wave having said second frequency and full wave rectified said AC Power Wave of said first frequency.

18. An apparatus as in claim 16 wherein the opto-isolator is connected to a gate of a semiconductor switch to turn-on the semiconductor switch when the LED illuminates.

19. A method for the conversion of AC power to DC power, comprising the steps of:
inputting AC power of a first frequency;
modulating the AC power into a first modulated power waveform of a second frequency that is greater than the first frequency;
transforming the first modulated power waveform into a second modulated power waveform at a transformer;
rectifying the second modulated power waveform into a rectified DC power output;
outputting said DC power output.

20. A method as in claim 19 wherein said step of transforming the first modulated power waveform comprises a step-up transformation.

21. A method as in claim 19 wherein said step of transforming the first modulated power waveform by said transformer comprises isolation.

22. A method as in claim 19, further comprising a step of filtering said rectified DC power output.

23. A method as in claim 19, further comprising a step of filtering said inputted AC power of a first frequency.

24. A method as in claim 19 wherein the step of modulating the AC power comprises pulse width modulation (PWM).

25. A method as in claim 19 wherein the step of modulating the AC power comprises frequency modulation of the second frequency.

26. A method as in claim 19 wherein the second frequency is at least ten times greater than the first frequency.

27. A method as in claim 24 wherein the second frequency is comprised of at least nine positive voltage pulses and at least nine negative voltage pulses within each cycle of the first frequency.

28. A method as in claim 24 wherein the PWM is variable frequency PWM.

29. A method as in claim 19 wherein the first modulated power waveform of said second frequency is produced by the product of said AC Power wave of said first frequency and a carrier wave of said second frequency.

30. A method as in claim 19, further comprising a step of reducing harmonic currents caused on said inputted AC power.

31. A method as in claim 22 wherein the inputted AC power source is a three-phase source.

32. A method as in claim 19 wherein said modulating step comprises optically-isolating said inputted AC power from said DC power output.

33. A method as in claim 19 wherein the first modulated power waveform of said second frequency is produced by the product of a carrier wave of said second frequency and the absolute value of said AC Power wave of said first frequency.
